(19) United States
(12) Patent Application Publication
(10) Pub. No.: US 2026/0145537 A1
(43) Pub. Date: May 28, 2026

(54) BATTERY PACK AND OPERATING METHOD THEREOF

(71) Applicant: Samsung SDI Co., Ltd., Yongin-si (KR)

(72) Inventors: Min Su Kim, Suwon-si (KR); Tae Ho Kim, Suwon-si (KR)

(73) Assignee: Samsung SDI Co., Ltd., Yongin-si (KR)

(21) Appl. No.: 19/316,631

(22) Filed: Sep. 2, 2025

(30) Foreign Application Priority Data
Nov. 26, 2024 (KR) 10-2024-0171343

(51) Int. Cl. B60L 3/00; B60L 58/18; H01M 10/42

(52) U.S. Cl. CPC B60L 3/0084; B60L 58/18; H01M 10/425; H01M 2010/4271

(57) ABSTRACT

The present disclosure relates to a battery pack, an operating method thereof, and a battery management device, and a technical problem to be solved is to propose a mechanism that enables the efficiency and reliability of wireless communication between a master battery management system (BMS) and a slave BMS to be improved. To this end, the present disclosure is directed to providing a configuration in which a master BMS transmits a control command to a slave BMS through a unidirectional communication method.

### CROSS-REFERENCE TO RELATED APPLICATIONS

This present application claims priority to and the benefit under 35 U.S.C. § 119(a)-(d) of Korean Patent Application No. 10-2024-0171343, filed on Nov. 26, 2024, in the Korean Intellectual Property Office, the entire disclosure of which is incorporated herein by reference.

### FIELD

The present disclosure relates to a battery pack and an operating method thereof.

### BACKGROUND

Electric vehicles (xEVs) are eco-friendly transportations that replace conventional internal combustion engine vehicles and are rapidly spreading around the world. xEVs include pure battery electric vehicles (BEVs), plug-in hybrid vehicles (PHEVs), hybrid electric vehicles (HEVs), etc., and their core components are high-performance battery systems. A battery management system (BMS) is essentially used for efficient management and monitoring of these battery systems.

A BMS serves to monitor and control the battery's charging status, health status, temperature, etc. in real time to optimize the performance and lifetime of the battery. Recently, the development of a battery system including a BMS to which wireless communication is applied is actively underway. A battery system including a BMS to which wireless communication is applied is composed of a plurality of slave BMSs (or node BMSs) configured to manage battery modules, and a master BMS (or manager BMS) configured to manage the plurality of slave BMSs through wireless communication. Such a battery system allows the number of wirings provided inside a battery pack to be reduced, and thus the weight of the battery pack can be reduced, and the ease of maintenance of the battery pack can be improved.

The herein information disclosed in this Background section is for enhancement of understanding of the background of the present disclosure, and therefore, it may contain information that does not constitute related (or prior) art.

### SUMMARY

The present disclosure is directed to providing a battery pack and an operating method thereof that are capable of improving the efficiency and reliability of wireless communication between a master battery management system (BMS) and a slave BMS.

However, objects that the present disclosure intends to achieve are not limited to the herein-described objects and other objects that are not described may be clearly understood by those skilled in the art from the following description.

According to aspects of the present disclosure, there is provided a battery pack, which includes a plurality of slave BMSs that are each provided in one battery module among battery modules, and a master BMS configured to wirelessly communicate with the plurality of slave BMSs, wherein the master BMS generates a control command for controlling at least one battery cell, encrypts the control command to generate first encrypted data, generates first integrity data from the first encrypted data, generates a data packet from the first encrypted data and the first integrity data, and transmits the data packet to an external device.

The control command may include a command code indicating a type of command, module identification information indicating a battery module that is a target of the command, and cell identification information indicating a battery cell that is a target of the command.

The cell identification information on the battery cell may be expressed as a bit mask.

The master BMS may generate a session key from a pre-shared key and encrypt the control command using the session key.

The master BMS may hash a portion of the first encrypted data to obtain a first hash value and perform an exclusive or (XOR) operation on the first hash value and the command code to generate the first integrity data.

The master BMS may generate a first data packet including the first encrypted data and the first integrity data, generate a first message authentication code for the first data packet, generate a second data packet including the first data packet and the first message authentication code, and transmit the second data packet to an external device.

The slave BMS may receive the second data packet and verify integrity of the first data packet included in the second data packet using the first message authentication code included in the second data packet.

The slave BMS may generate a second message authentication code for the first data packet, and when the second message authentication code matches the first message authentication code, determine that the first data packet has not been altered or damaged.

The slave BMS may decrypt the first encrypted data included in the first data packet whose integrity has been verified to obtain a control command, verify integrity of the control command using the first integrity data included in the first data packet, and perform the control command whose integrity has been verified.

The slave BMS may generate second integrity data from the first encrypted data, and when the second integrity data matches the first integrity data, determine that the control command has not been altered or damaged.

According to aspects of the present disclosure, there is provided an operating method of a battery pack, which includes generating, by a master BMS, a control command for controlling at least one battery cell, encrypting, by the master BMS, the control command and generating first encrypted data, generating, by the master BMS, first integrity data from the first encrypted data, generating, by the master BMS, a data packet from the first encrypted data and the first integrity data, and transmitting the data packet to an external device by wireless communication.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a block diagram illustrating a battery pack according to embodiments of the present disclosure;

FIG. 2 is an exemplary diagram for describing a data change process in the battery pack according to embodiments of the present disclosure;

FIG. 3 is a first flowchart illustrating an operating method of the battery pack according to embodiments of the present disclosure; and

FIG. 4 is a second flowchart illustrating the operating method of the battery pack according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked,” or “connected” to another element, the elements may be directly “coupled,” “linked,” or “connected” to each other, or an intervening element may be present therebetween, through which the element may be “coupled,” “linked,” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

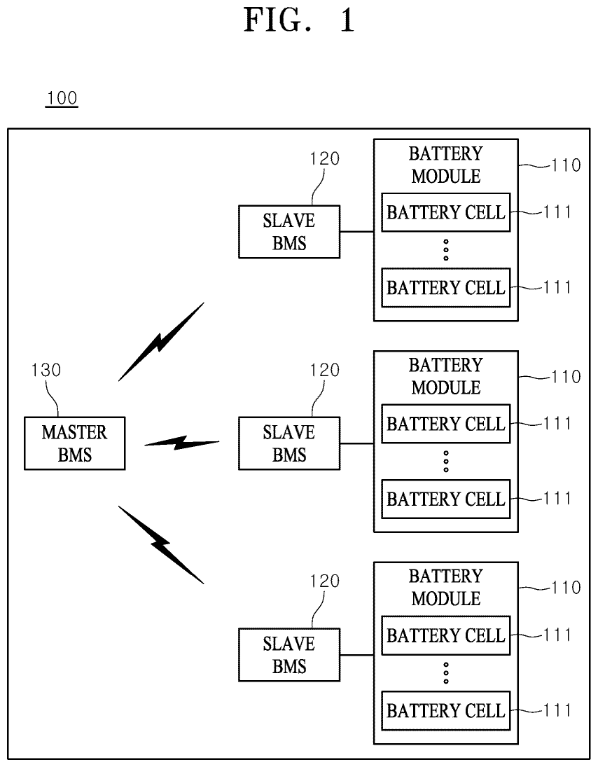

FIG. 1 is a block diagram of a battery pack according to embodiments of the present disclosure.

Referring to FIG. 1, a battery pack 100 according to embodiments of the present disclosure may include at least one battery module 110, at least one slave battery management device (hereinafter referred to as a “slave battery management system (BMS)”) 120, and a master battery management device (hereinafter referred to as a “master BMS”) 130. The battery pack 100 may include a pack housing in which an accommodation space for accommodating a plurality of battery modules 110 is formed. The battery pack 100 according to embodiments of the present disclosure may further include various components in addition to the components illustrated in FIG. 1.

The battery modules 110 may each include a plurality of battery cells 111 and a module housing. The battery modules 110 may each include the plurality of battery cells 111 connected to each other in series or in parallel. The battery modules 110 may be connected to each other in series or in parallel.

The battery cells 111 may be accommodated in a stacked form inside the module housing. The battery cell 111 may include a positive lead and a negative lead. Various types of battery cells 111, such as a circular type, a prismatic type, and a pouch type, may be used to form the battery module 110.

In the battery pack 100, a single cell stack in which battery cells are stacked forms one module instead of the battery module 110. The cell stack may be accommodated in the accommodation space of the pack housing or accommodated in an accommodation space in the battery pack 100 that is partitioned by a frame, a partition, etc.

The battery cell 111 may generate a large amount of heat during charging/discharging. The generated heat may accumulate in the battery cell 111 and accelerate the degradation of the battery cell 111. Therefore, the battery pack 100 may further include a cooling member to suppress the degradation of the battery cell 111. The cooling member may be provided at a lower portion of the accommodation space in which the battery cell 111 is provided, but the present is not limited thereto, and the cooling member may be provided at an upper portion or a side surface depending on the battery pack 100.

Exhaust gas inside the battery cell 111 that is generated under abnormal operating conditions known as even thermal runaway or a thermal event may be discharged to the outside of the battery cell 111. The battery pack 100 or the battery module 110 may include an exhaust port or the like for discharging exhaust gas to suppress damage to the battery pack 100 or battery module 110.

The slave BMS 120 may manage the battery module 110. The slave BMS 120 may detect the status (voltage, current, temperature, etc.) of the battery module 110 and generate status information indicating the status of the battery module 110 on the basis of a result of the detection. The slave BMS 120 may detect the status (voltage, current, temperature, etc.) of each of the battery cells 111 constituting the battery module 110 and generate status information indicating the status of each battery cell 111 on the basis of a result of the detection.

The master BMS 130 may manage the battery pack 100. The master BMS 130 may detect the status (voltage, current, temperature, etc.) of the battery pack 100 and generate status information indicating the status of the battery pack 100 on the basis of a result of the detection. The master BMS 130 may detect the status (voltage, current, temperature, etc.) of each of the battery modules 110 constituting the battery pack 100 and generate status information indicating the status of each battery module 110 on the basis of a result of the detection.

The master BMS 130 may wirelessly communicate with each of the slaves BMS 120 connected to each battery module 110. The master BMS 130 may receive and process data transmitted from each slave BMS 120. The master BMS 130 may transmit the data to the slave BMS 120 to control the slave BMS 120. The master BMS 130 may communicate with an external device in a wireless and/or wired manner.

The master BMS 130 may generate a control command for controlling at least one battery cell and encrypt the generated control command to generate first encrypted data. The control command may include a command code, which is information indicating the type of command, module identification information, which is information indicating the battery module 110 that is a target of the command, and cell identification information, which is information indicating at least one battery cell 111 that is a target of the command. One or more battery cells 111 may be the targets of the command, and thus the cell identification information may include identification information on the one or more battery cells 111.

The cell identification information may be expressed as a bit mask. For example, assuming that the battery module 110 may include 16 battery cells 111, and the battery cells 111 that are the targets of the command are 4^{th}, 8^{th}, 11^{th}, 12^{th}, and 14^{th} battery cells 111, the cell identification information may be expressed (interpreted from the right) as “0x2C88”=(0010 1100 1000 1000). In the present embodiment, by including the cell identification information expressed as the bit mask in the control command, the plurality of battery cells 111 may be simultaneously controlled using one command.

The master BMS 130 may generate a session key from a pre-shared key set to be shared in advance with the slave BMS 120 and encrypt the control command using the generated session key to generate the first encrypted data. In this case, the master BMS 130 may generate the session key from the pre-shared key using a hash-based message authentication code (HMAC)-based key derivation function (HKDF). The HKDF may be a key derivation function that operates based on HMAC. Meanwhile, the key derivation function used to generate the session key is not limited to the herein embodiment, and various known key derivation functions may be used to generate the session key from the pre-shared key. The master BMS 130 may periodically generate the session key from the pre-shared key to update the session key. The master BMS 130 may periodically transmit a key update command to the slave BMS 120 so that the session key is periodically updated even in the slave BMS 120.

The master BMS 130 may encrypt the control command using ChaCha20. ChaCha20 may be a symmetric key-based stream encryption algorithm. Meanwhile, the algorithm used to encrypt the control command is not limited to the herein embodiment, and various known encryption algorithms may be used to encrypt the control command.

The master BMS 130 may generate first integrity data from the first encrypted data. The master BMS 130 may hash a portion of the first encrypted data to obtain a first hash value and perform an XOR operation on the obtained first hash value and the command code included in the control command to generate the first integrity data. In this case, the master BMS 130 may hash the portion of the first encrypted data using BLAKE2s. BLAKE2s is a lightweight hash function that can provide fast speed and strong security. Meanwhile, the algorithm for hashing the portion of the first encrypted data is not limited to the herein embodiment, and various known hash functions may be used to hash the first encrypted data. The first integrity data may be used to verify the integrity of the control command in the slave BMS 120.

The master BMS 130 may generate a data packet from the first encrypted data and the first integrity data and transmit the generated data packet to an external device (e.g., the slave BMS 120). The master BMS 130 may generate a first data packet including the first encrypted data and the first integrity data, generate a first message authentication code (cipher-based message authentication code (CMAC)) for the generated first data packet, generate a second data packet including the generated first message authentication code and the first data packet, and transmit the generated second data packet to an external device (e.g., the slave BMS 120).

The master BMS 130 may add a packet header to the first encrypted data and the first integrity data to generate the first data packet. The first data packet may be composed of the packet header, the first encrypted data, and the first integrity data. The packet header may include packet identification information, command type information, which is information indicating the type of command, and a timestamp, which is information indicating a generation time of the command. The packet identification information is information for identifying a packet and may be randomly generated using a preset algorithm.

The master BMS 130 may generate the first message authentication code for the first data packet using advanced encryption standard (AES)-CMAC. The master BMS 130 may generate the first message authentication code using a symmetric block cipher such as the AES. The first message authentication code may be used to verify the integrity of the first data packet in the slave BMS 120. The master BMS 130 may generate a CMAC key (AES-128 encryption result) using a shared key that is pre-shared, pad the first data packet to a multiple of the block size (e.g., 16 bytes), generate two sub-keys using a preset algorithm, and process the padded first data packet in units of blocks to generate the first message authentication code.

The master BMS 130 may add the first message authentication code to the first data packet to generate the second data packet. The second data packet may be composed of the first data packet and the first message authentication code.

The slave BMS 120 may receive the second data packet transmitted from the master BMS 130 and verify the integrity of the first data packet included in the second data packet using the first message authentication code included in the received second data packet.

The slave BMS 120 may generate a second message authentication code for the first data packet included in the second data packet, compare the generated second message authentication code with the first message authentication code to determine whether the first message authentication code matches the second message authentication code, and when the first message authentication code matches the second message authentication code, determine that the first data packet included in the second data packet has not been altered and damaged. The slave BMS 120 may generate the second message authentication code in the same manner as the master BMS 130. That is, the slave BMS 120 may generate the second message authentication code for the first data packet using AES-CMAC. When the first message authentication code does not match the second message authentication code, the slave BMS 120 may determine that the first data packet included in the second data packet has been altered and damaged and discard the corresponding data packet. After the slave BMS 120 discards the data packet, the slave BMS 120 may perform a preset error handling operation (e.g., an operation of requesting retransmission of the data packet from the master BMS 130).

The slave BMS 120 may decrypt the first encrypted data included in the first data packet to obtain a control command and verify the integrity of the control command using the obtained control command and the first integrity data included in the first data packet. The slave BMS 120 may decrypt the first encrypted data using a session key generated from the pre-shared key. When the key update command transmitted from the master BMS 130 is received, the slave BMS 120 may regenerate the session key from the pre-shared key to update the session key. The slave BMS 120 may perform the operation of obtaining the control command and the operation of verifying the integrity of the control command only when the integrity of the first data packet is confirmed.

The slave BMS 120 may generate second integrity data from the first encrypted data, compare the generated second integrity data with the first integrity data to determine whether the first integrity data matches the second integrity data, and when the first integrity data matches the second integrity data, determine that the control command has not been altered and damaged. The slave BMS 120 may generate the second integrity data in the same manner as the master BMS 130. The slave BMS 120 may hash a portion of the first encrypted data using BLAKE2s to obtain a second hash value and perform an XOR operation on the obtained second hash value and the command code included in the control command to generate the second integrity data. When the first integrity data does not match the second integrity data, the slave BMS 120 may determine that the command code (first encrypted data) has been altered and damaged and discard the corresponding data packet. After the slave BMS 120 discards the data packet, the slave BMS 120 may perform a preset error handling operation (e.g., an operation of requesting retransmission of the data packet from the master BMS 130).

The slave BMS 120 may execute the control command whose integrity has been verified. The slave BMS 120 may perform an operation corresponding to the command code included in the control command on the battery cell 111 corresponding to the cell identification information. For example, assuming that the cell identification information is “0x2C88” and the command code is “0xA3” (indicating a cell balancing operation), the slave BMS 120 may control the battery module 110 so that cell balancing is performed on the 4^{th}, 8^{th}, 11^{th}, 12^{th}, and 14^{th} battery cells 111 corresponding to “0x2C88” (0010 1100 1000 1000). In this case, among the slave BMSs 120 included in the battery pack 100, only the slave BMS 120 corresponding to the module identification information included in the control command may execute the control command.

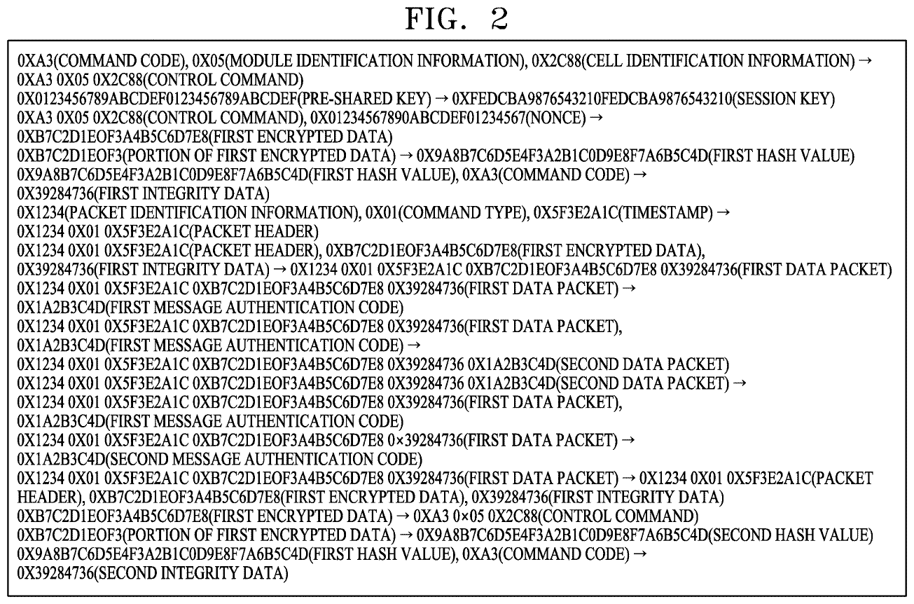

FIG. 2 is an exemplary diagram for describing a data change process in the battery pack according to embodiments of the present disclosure.

Hereinafter, changes in the format of data in a process for transmitting a control command for balancing the 4^{th}, 8^{th}, 11^{th}, 12^{th}, and 14^{th} battery cells 111 included in a 5^{th} battery module will be described with reference to FIG. 2.

First, the master BMS 130 may generate a control command for balancing the 4^{th}, 8^{th}, 11^{th}, 12^{th}, and 14^{th} battery cells among a total of 16 battery cells included in the 5^{th} battery module. The master BMS 130 may generate a control command “0xA3 0x05 0x2C88” by combining “0xA3,” which is a command code corresponding to cell balancing, “0x05,” which is module identification information corresponding to the 5th battery module, and “0x2C 88,” which is cell identification information (bit mask) corresponding to the 4^{th}, 8^{th}, 11^{th}, 12^{th}, and 14^{th} battery cells. Next, the master BMS 130 may generate a session key “0XFEDCBA9876543210FEDCBA9876543210” from a pre-shared key “0x0123456789ABCDEF-0123456789ABCDEF.”

Next, the master BMS 130 may encrypt the control command “0xA3 0x05 0x2C88” to generate first encrypted data “0xB7C2D1E0F3A4B5C6D7E8.” In this case, the master BMS 130 may encrypt the control command using the previously generated session key, and in this case, “0x01234567890ABCDEF01234567” may be used as the nonce.

Next, the master BMS 130 may hash “0xB7C2D1E0F3,” which is a portion of the first encrypted data “0xB7C2D1E0F3A4B5C6D7E8” to obtain a first hash value “0x9A8B7C6D5E4F3A2B1C0-D9E8F7A6B5C4D,” and perform an XOR operation on the obtained first hash value and the command code “0xA3” to generate first integrity data “0x39284736.”

Next, the master BMS 130 may add a packet header “0x1234 0x01 0x5F3E2A1C” to the first encrypted data “0xB7C2D1E0F3A4B5C6D7E8” and the first integrity data “0x39284736” to generate a first data packet “0x1234 0x01 0x5F3E2A1C 0xB7C2D1E0F3A4B5C6D7E8 0x39284736.” In the packet header, “0x1234” may be packet identification information, “0x01” may be command type information, and “0x5F3E2A1C” may be a timestamp.

Next, the master BMS 130 may generate a first message authentication code “0x1A2B3C4D” for the first data packet “0x1234 0x01 0x5F3E2A1C 0xB7C2D1E0F3A4B5C6D7E8 0x39284736” using AES-CMAC. For example, the master BMS 130 may extract a first data block (e.g., the most significant n bits) from the first data packet (padded data), perform an XOR operation on the extracted first data block and a preset initial vector (e.g., 128 bits with all 0s) to calculate a first result value, AES encrypt the calculated first result value with a CMAC key to calculate a second result value, extract a second data block (the remaining bits except for the first data block) from a second data packet, perform an XOR operation on the extracted second data block and the second result value to calculate a third result value, AES encrypt the calculated third result value with the CMAC key to calculate a 4^{th} result value, perform an XOR operation on the calculated 4^{th} result value and a preset sub-key to calculate a 5^{th} result value, and AES encrypt the calculated 5^{th} result value with the CMAC key to calculate a 6^{th} result value (CMAC). The master BMS 130 may use a portion (e.g., first 4 bytes) of the 6^{th} result value as the first message authentication code.

Next, the master BMS 130 may generate a second data packet “0x1234 0x01 0x5F3E2A1C 0xB7C2D1E0F3A4B5C6D7E8 0x39284736 0x1A2B3C4D” by combining the first data packet “0x1234 0x01 0x5F3E2A1C 0xB7C2D1E0F3A4B5C6D7E8 039284736” and the first message authentication code “0x1A2B3C4D,” and transmit the generated second data packet to an external device through wireless communication.

The slave BMS 120 may receive the second data packet and generate a second message authentication code for the first data packet included in the second data packet.

When the first data packet has not been altered and damaged, the second message authentication code may be “0x1A2B3C4D,” which is the same as the first message authentication code, and when the second message authentication code is “0x1A2B3C4D,” the slave BMS 120 may determine that the first data packet has not been altered and damaged.

When the integrity of the first data packet is verified, the slave BMS 120 may decrypt the first encrypted data included in the first data packet to obtain a control command, hash a portion of the first encrypted data included in the first data packet to obtain a second hash value, and perform an XOR operation on the obtained second hash value and the command code included in the previously obtained control command to generate second integrity data. When the control command has not been altered and damaged, the second integrity data may be “0x39284736,” which is the same as the first integrity data, and when the second integrity data is “0x39284736,” the slave BMS 120 may determine that the control command has not been altered and damaged.

When the integrity of the control command is verified, the slave BMS 120 may perform an operation corresponding to the control command “0xA3 0x05 0x2C88,” that is, balancing, on the 4^{th}, 8^{th}, 11^{th}, 12^{th}, and 14^{th} battery cells. In this case, only the slave BMS 120 managing the 5^{th} battery module may perform the cell balancing operation.

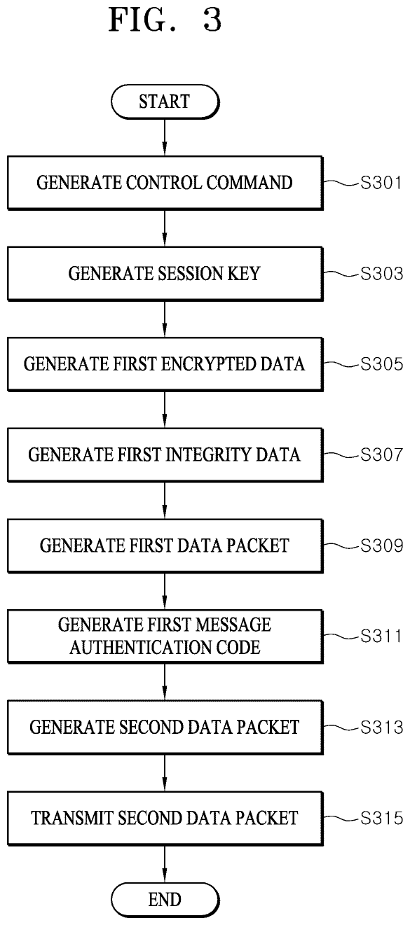

FIG. 3 is a first flowchart illustrating an operating method of the battery pack according to embodiments of the present disclosure.

Hereinafter, the operating method of the battery pack 100 according to embodiments of the present disclosure will be described with a focus on an operation of the master BMS 130 with reference to FIG. 3.

First, the master BMS 130 may generate a control command for controlling at least one battery cell (S301). In operation S301, the master BMS 130 may generate the control command by combining a command code, module identification information, and cell identification information.

Next, the master BMS 130 may generate a session key from a pre-shared key (S303). In operation S303, the master BMS 130 may generate the session key from the pre-shared key using an HKDF.

Next, the master BMS 130 may encrypt the control command using the session key to generate first encrypted data (S305). In operation S305, the master BMS 130 may encrypt the control command using ChaCha20.

Next, the master BMS 130 may generate first integrity data from the first encrypted data (S307). In operation S307, the master BMS 130 may hash a portion of the first encrypted data to obtain a first hash value and perform an XOR operation on the obtained first hash value and command code included in the control command to generate the first integrity data. In operation S307, the master BMS 130 may hash the portion of the first encrypted data using BLAKE2s.

Next, the master BMS 130 may generate a first data packet on the basis of the first encrypted data and the first integrity data (S309). In operation S309, the master BMS 130 may generate the first data packet by combining the first encrypted data, the first integrity data, and a packet header. The master BMS 130 may generate the packet header by combining packet identification information, command type information, and a timestamp.

Next, the master BMS 130 may generate a first message authentication code for the first data packet (S311). In operation S311, the master BMS 130 may generate the first message authentication code for the first data packet using AES-CMAC.

Next, the master BMS 130 may generate a second data packet on the basis of the first data packet and a second message authentication code (S313). In operation S313, the master BMS 130 may generate the second data packet by combining the first data packet and the second message authentication code.

Next, the master BMS 130 may transmit the second data packet to an external device (slave BMS 120) through wireless communication (S315).

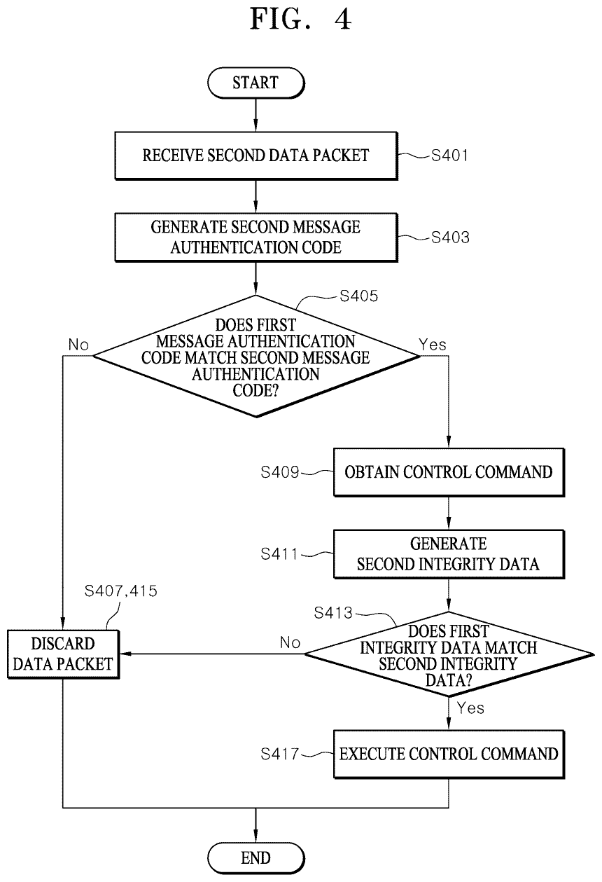

FIG. 4 is a second flowchart illustrating the operating method of the battery pack according to embodiments of the present disclosure.

Hereinafter, the operating method of the battery pack 100 according to embodiments of the present disclosure will be described with a focus on an operation of the slave BMS 120 with reference to FIG. 4.

First, the slave BMS 120 may receive the second data packet transmitted from the master BMS 130 (S401).

Next, the slave BMS 120 may generate a second message authentication code for the first data packet included in the second data packet (S403). In operation S403, the slave BMS 120 may generate the second message authentication code for the first data packet using AES-CMAC.

Next, the slave BMS 120 may compare the first message authentication code with the second message authentication code to determine whether the first message authentication code matches the second message authentication code (S405).

When the first message authentication code does not match the second message authentication code, the slave BMS 120 may determine that the first data packet has been altered and damaged and discard the corresponding data packet (S407). Further, the slave BMS 120 may perform a preset error handling operation (e.g., an operation of requesting retransmission of the data packet from the master BMS 130).

On the other hand, when the first message authentication code matches the second message authentication code, the slave BMS 120 may decrypt the first encrypted data included in the first data packet to obtain the control command (S409). In operation S409, the slave BMS 120 may decrypt the first encrypted data using a session key generated from the pre-shared key.

Next, the slave BMS 120 may generate second integrity data from the first encrypted data (S411). In operation S411, the slave BMS 120 may hash a portion of the first encrypted data to obtain a second hash value and perform an XOR operation on the obtained second hash value and command code included in the control command to generate the second integrity data. In operation S411, the slave BMS 130 may hash the portion of the first encrypted data using BLAKE2s.

Next, the slave BMS 120 may compare the first integrity data with the second integrity data to determine whether the first integrity data matches the second integrity data (S413).

When the first integrity data does not match the second integrity data, the slave BMS 120 may determine that the first data packet has been altered and damaged and discard the corresponding data packet (S415). Further, the slave BMS 120 may perform a preset error handling operation.

On the other hand, when the first integrity data matches the second integrity data, the slave BMS 120 may execute the control command (S417). In operation S417, the slave BMS 120 may perform an operation corresponding to the command code included in the control command on the battery cell 111 corresponding to the cell identification information. In this case, among the slave BMSs 120 included in the battery pack 100, only the slave BMS corresponding to the module identification information included in the control command may execute the control command.

As described herein, according to the present disclosure, the integrity of a data packet (control command) transmitted from a master BMS to a slave BMS can be rapidly verified, and thus any alteration or damage to the data packet transmitted from the master BMS to the slave BMS can be easily detected.

Further, according to the present disclosure, by ensuring accurate transmission of a data packet, a response operation indicating that a slave BMS has received a data packet transmitted from a master BMS without an error during a communication process between the master BMS and the slave BMS can be omitted, and thus communication delay and power consumption caused by the response operation of the slave BMS can be reduced.

Further, according to the present disclosure, by adopting a unidirectional communication structure that does not require a response operation of a slave BMS, a communication load can be prevented from rapidly increasing as the number of slave BMSs increases, a response speed for a real-time control task such as cell balancing can be improved, and a protocol stack can be simplified.

According to the present disclosure, the integrity of a data packet (control command) transmitted from a master BMS to a slave BMS can be rapidly verified, and thus any alteration or damage to the data packet transmitted from the master BMS to the slave BMS can be easily detected.

Further, according to the present disclosure, by ensuring accurate transmission of a data packet, a response operation indicating that a slave BMS has received a data packet transmitted from a master BMS without an error during a communication process between the master BMS and the slave BMS can be omitted, and thus communication delay and power consumption caused by the response operation of the slave BMS can be reduced.

Further, according to the present disclosure, by adopting a unidirectional communication structure that does not require a response operation of a slave BMS, a communication load can be prevented from rapidly increasing as the number of slave BMSs increases, a response speed for a real-time control task such as cell balancing can be improved, and a protocol stack can be simplified.

However, effects that can be achieved through the present disclosure are not limited to the herein-described effects and other effects that are not described may be clearly understood by those skilled in the art from the detailed descriptions.

The embodiments described herein may be implemented, for example, as a method or process, a device, a software program, a data stream, or a signal. Although discussed in the context of a single type of implementation (for example, discussed only as a method), features discussed herein may also be implemented in other forms (for example, a device or a program). The device may be implemented by suitable hardware, software, firmware, and the like. The method may be implemented on a device, such as a processor that generally refers to a processing device including a computer, a microprocessor, an integrated circuit, a programmable logic device, etc. The processor includes a communication device such as a computer, a cell phone, a personal digital assistant (PDA), and other devices that facilitate communication of information between the device and end-users.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, herein.

What is claimed is:

1. A battery pack comprising:
a plurality of slave battery management systems (BMSs) that are each provided in one battery module among battery modules; and
a master BMS configured to wirelessly communicate with the plurality of slave BMSs,
wherein the master BMS generates a control command for controlling at least one battery cell, encrypts the control command to generate first encrypted data, generates first integrity data from the first encrypted data, generates a data packet from the first encrypted data and the first integrity data, and transmits the data packet to an external device.

2. The battery pack of claim 1, wherein the control command includes a command code indicating a type of command, module identification information indicating a battery module that is a target of the command, and cell identification information indicating a battery cell that is a target of the command.

3. The battery pack of claim 2, wherein the cell identification information on the battery cell is expressed as a bit mask.

4. The battery pack of claim 1, wherein the master BMS generates a session key from a pre-shared key and encrypts the control command using the session key.

5. The battery pack of claim 2, wherein the master BMS hashes a portion of the first encrypted data to obtain a first hash value and performs an exclusive or (XOR) operation on the first hash value and the command code to generate the first integrity data.

6. The battery pack of claim 1, wherein the master BMS generates a first data packet including the first encrypted data and the first integrity data, generates a first message authentication code for the first data packet, generates a second data packet including the first data packet and the first message authentication code, and transmits the second data packet to an external device.

7. The battery pack of claim 6, wherein the slave BMS receives the second data packet and verifies integrity of the first data packet included in the second data packet using the first message authentication code included in the second data packet.

8. The battery pack of claim 7, wherein the slave BMS generates a second message authentication code for the first data packet, and when the second message authentication code matches the first message authentication code, determines that the first data packet has not been altered or damaged.

9. The battery pack of claim 7, wherein the slave BMS decrypts the first encrypted data included in the first data packet whose integrity has been verified to obtain a control command, verifies integrity of the control command using the first integrity data included in the first data packet, and performs the control command whose integrity has been verified.

10. The battery pack of claim 9, wherein the slave BMS generates second integrity data from the first encrypted data, and when the second integrity data matches the first integrity data, determines that the control command has not been altered or damaged.

11. An operating method of a battery pack, comprising:
generating, by a master battery management system (BMS), a control command for controlling at least one battery cell;
encrypting, by the master BMS, the control command and generating first encrypted data;
generating, by the master BMS, first integrity data from the first encrypted data;
generating, by the master BMS, a data packet from the first encrypted data and the first integrity data; and
transmitting the data packet to an external device by wireless communication.

12. The operating method of claim 11, wherein the control command includes a command code indicating a type of command, module identification information indicating a battery module that is a target of the command, and cell identification information indicating a battery cell that is a target of the command.

13. The operating method of claim 12, wherein the cell identification information on the battery cell is expressed as a bit mask.

14. The operating method of claim 11, wherein, in the generating of the first encrypted data, the master BMS generates a session key from a pre-shared key and encrypts the control command using the session key.

15. The operating method of claim 12, wherein, in the generating of the first integrity data, the master BMS hashes a portion of the first encrypted data to obtain a first hash value and performs an exclusive or (XOR) operation on the first hash value and the command code to generate the first integrity data.

16. The operating method of claim 11, wherein, in the generating of the data packet, the master BMS generates a first data packet including the first encrypted data and the first integrity data, generates a first message authentication code for the first data packet, and generates a second data packet including the first data packet and the first message authentication code.

17. The operating method of claim 16, further comprising:
receiving, by a slave BMS, the second data packet; and
verifying, by the slave BMS, integrity of the first data packet included in the second data packet using the first message authentication code included in the second data packet.

18. The operating method of claim 17, wherein, in the verifying of the integrity of the first data packet, the slave BMS generates a second message authentication code for the first data packet, and when the second message authentication code matches the first message authentication code, determines that the first data packet has not been altered or damaged.

19. The operating method of claim 17, further comprising:
after the verifying of the integrity of the first data packet, decrypting, by the slave BMS, the first encrypted data included in the first data packet whose integrity has been verified and obtaining a control command;
verifying, by the slave BMS, integrity of the control command using the first integrity data included in the first data packet; and
performing, by the slave BMS, the control command whose integrity has been verified.

20. The operating method of claim 19, wherein, in the verifying of the integrity of the control command, the slave BMS generates second integrity data from the first encrypted data, and when the second integrity data matches the first integrity data, determines that the control command has not been altered or damaged.
